(19) United States
(12) Patent Application Publication
(10) Pub. No.: US 2025/0035823 A1
(43) Pub. Date: Jan. 30, 2025

(54) OPTICAL CONSTRUCTION INCLUDING LENS FILM AND MASK LAYER

(71) Applicant: 3M INNOVATIVE PROPERTIES COMPANY, St. Paul, MN (US)

(72) Inventors: Kundapur Raveesh Shenoy, Woodbury, MN (US); Tri D. Pham, Woodbury, MN (US); Charles J. Studiner, Cottage Grove, MN (US); Zhaohui Yang, North Oaks, MN (US); Martin E. Denker, Vadnais Heights, MN (US); Neeraj Sharma, Lake Elmo, MN (US); Jung-Sheng Wu, Woodbury, MN (US)

(21) Appl. No.: 18/716,565

(22) PCT Filed: Nov. 29, 2022
(86) PCT No.: PCT/IB2022/061547

§ 371 Date: Jun. 5, 2024

Related U.S. Application Data
(60) Provisional application No. 63/289,420, filed on Dec. 14, 2021.

(51) Int. Cl. G02B 3/00; G02B 5/00

(52) U.S. Cl. CPC G02B 3/0037; G02B 5/005

(57) ABSTRACT

An optical construction includes a lens film having an outermost structured first major surface and an opposing outermost substantially planar second major surface. The first major surface includes a plurality of microlenses. A radiation cured optically opaque mask layer is disposed on the second major surface of the lens film. The mask layer has an average thickness of less than about 10 microns and defines a plurality of laser-ablated through openings therein. The through openings are aligned to the microlenses in a one-to-one correspondence, such that for a light incident on the structured first major surface along an incident direction forming an incident angle with the second major surface, an optical transmittance of the optical construction as a function of a transmitted angle includes a first transmitted peak having a first peak transmittance T1≥40%. The first transmitted peak can be within about 10 degrees of the incident angle.

### BACKGROUND

An optical device can include a microlens array and a mask including an array of pinholes.

### SUMMARY

The present disclosure relates generally to optical constructions and methods of making optical constructions. An optical construction can include a lens film and a radiation cured mask layer disposed on the lens film that includes a plurality of laser-ablated through openings therein.

In some aspects of the present disclosure, an optical construction is provided. The optical construction includes a lens film including an outermost structured first major surface and an opposing outermost substantially planar second major surface. The structured first major surface includes a plurality of microlenses arranged along orthogonal first and second directions. The optical construction includes a radiation cured optically opaque mask layer disposed on the second major surface of the lens film. The mask layer has an average thickness of less than about 10 microns and defines a plurality of laser-ablated through openings therein arranged along the first and second directions. The through openings are aligned to the microlenses in a one-to-one correspondence, such that for a substantially collimated light incident on the structured first major surface side of the optical construction along an incident direction forming an incident angle with the second major surface, an optical transmittance of the optical construction as a function of a transmitted angle includes a first transmitted peak having a first peak transmittance T1 and a corresponding full width at half maximum W1. The first transmitted peak is within about 10 degrees of the incident angle. In some embodiments, T1³ 50% and T1/W1³ 4%/degree.

In some aspects of the present disclosure, an optical construction is provided. The optical construction includes a lens film including an outermost structured first major surface and an opposing outermost substantially planar second major surface. The structured first major surface includes a plurality of microlenses arranged along orthogonal first and second directions. The optical construction includes a radiation cured optically opaque mask layer disposed on the second major surface of the lens film. The mask layer has a third major surface facing the lens film and an opposing fourth major surface. An average separation between the third and fourth major surfaces can be less than about 10 microns. The mask layer defines a plurality of laser-ablated through openings therein arranged along the first and second directions. The through openings are aligned to the microlenses in a one-to-one correspondence, such that for a substantially collimated light incident on the structured first major surface side of the optical construction along an incident direction forming an incident angle with the second major surface, an optical transmittance of the optical construction as a function of a transmitted angle includes a first transmitted peak having a first peak transmittance T1³ 40%. For at least one of the third and fourth major surfaces, each through opening has an open end at the major surface having a shape having a circularity being 4p times an area of the shape divided by a square of a perimeter of the shape, the circularities of the shapes of the open ends of at least about 20% of the through openings being at least about 0.75, the areas of the shapes of the open ends of the through openings having an average A and a standard deviation of less than about 12% of A.

In some aspects of the present disclosure, an optical construction is provided. The optical construction includes a lens film including an outermost structured first major surface and an opposing outermost substantially planar second major surface. The structured first major surface includes a plurality of microlenses arranged along orthogonal first and second directions. The optical construction includes a radiation cured optically opaque mask layer disposed on the second major surface of the lens film. The mask layer has an average thickness of less than about 10 microns and defines a plurality of laser-ablated through openings therein arranged along the first and second directions. The through openings are aligned to the microlenses in a one-to-one correspondence, such that for a substantially collimated light incident on the structured first major surface side of the optical construction along an incident direction forming an incident angle with the second major surface, an optical transmittance of the optical construction as a function of a transmitted angle includes a first transmitted peak having a first peak transmittance T1³ 40%. In at least a first cross-section of the optical construction along a thickness direction of the optical construction and substantially bisecting a first opening in the plurality of through openings, the first opening includes opposing first and second sidewalls. A best linear fit to at least one of the first and second sidewalls has an r-squared value of greater than about 0.8.

In some aspects of the present disclosure, a method of making an optical construction is provided. The method includes providing a lens film including an outermost structured first major surface and an opposing outermost substantially planar second major surface, where the structured first major surface includes a plurality of microlenses arranged along orthogonal first and second directions; coating the second major surface of the lens film with a mixture comprising oligomer, optically absorptive material, and no more than about 25 weight percent monomer; radiation curing the coated mixture to form a mask layer having an average thickness of less than about 10 microns and a substantially uniform optical density of greater than about 1.5; and ablating a plurality of through openings in the mask layer using a laser emitting infrared light incident on the structured first major surface of the lens film such that the through openings are arranged along the first and second directions and are aligned to the microlenses in a one-to-one correspondence. Each through opening in at least a majority of the through openings has an optical density less than about 0.3. For at least one major surface of the mask layer, each through opening has an open end at the major surface having a shape having a circularity being 4p times an area of the shape divided by a square of a perimeter of the shape. The circularities of the shapes of the open ends of at least 20% of the through openings is at least about 0.75. The areas of the shapes of the open ends of the through openings having an average A and a standard deviation of less than about 15% of A.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-sectional view of an illustrative optical construction.

FIGS. 2A-2B are schematic cross-sectional views of illustrative optical constructions, according to some embodiments.

FIG. 3 is a top perspective view of an illustrative lens film.

FIG. 4 is a bottom perspective view image of an illustrative mask layer.

FIG. 5 is a schematic plot of an optical transmittance through an optical construction.

FIG. 6 is a schematic view of an illustrative open end of a through opening.

FIG. 7 is a schematic view of a cross-section of a portion of an optical construction.

FIGS. 8A-8C are schematic illustrations of steps in a method of making an optical construction, according to some embodiments.

FIG. 9 is a plot of a profile of a cross-section of through openings in a comparative optical construction.

FIG. 10 is a plot of a profile of a cross-sections of through openings in an exemplary optical construction.

FIG. 11 is a bottom view of a comparative optical construction.

FIG. 12 is a view of a cross-section through the optical construction of FIG. 11.

FIG. 13 is a plot of optical transmittance through exemplary optical constructions.

FIGS. 14-15 are plots of optical transmittances through comparative optical constructions.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

An optical construction can include a microlens array and a metal mask having an array of through openings (e.g., pinholes) corresponding to the microlenses. However, it has been found that using a metal mask can result in unwanted specular reflection from regions of the mask between through openings. A polymeric layer including optically absorptive material in place of a metal mask can be used. However, previous optical constructions using such polymeric layers have had through openings with poor shape definition which can result in undesirably broad peaks in optical transmittance through the through openings and/or can result in undesired cross-talk (e.g., light incident on one microlens may be transmitted through an adjacent through hole) and/or can result in undesirably low peak transmittance (unless large diameter through openings are used which would result in undesired cross-talk). For example, the resulting through openings can have open ends with low circularity and/or sidewalls that are jagged or irregular and/or the mask layer can have a low uniformity of area of the open ends. According to some embodiments, optically opaque mask layers are provided which provide a sharp peak in optical transmittance through the optical construction and/or provide through openings with substantially linear sidewalls and/or provide through openings having open ends with high circularity and/or provide through openings having a high uniformity of area of the open ends. The mask layer can be radiation cured. According to some embodiments, it has been found that radiation cured mask layers where the cured polymer has a low crosslinking density and/or is formed from a mixture having a low monomer content and comprising a oligomer with a high molecular weight per linking group can result in improved through-hole shape definition compared to using conventional coating when the through-holes are formed by laser ablation. Further, it has been found that the mask layer can be made at a sufficient thickness (e.g., about 2 microns to about 7 microns) to provide a high optical density (e.g., an optical density of at least about 1.5) while still providing good through hole shape definition.

In some embodiments, the optical constructions are useful as angular optical filters which can be used in a variety of applications such as fingerprint sensing applications, for example. The optical construction may be disposed between a fingerprint sensing area and a sensor in a device (e.g., cell phone) and can be adapted to transmit light reflected from a finger in the fingerprint sensing area to the sensor while rejecting light incident on the optical construction from different angles.

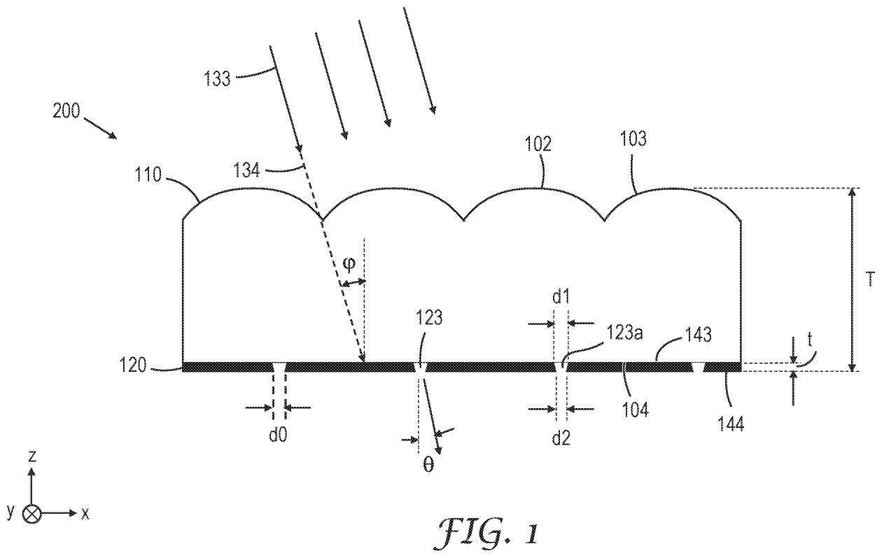

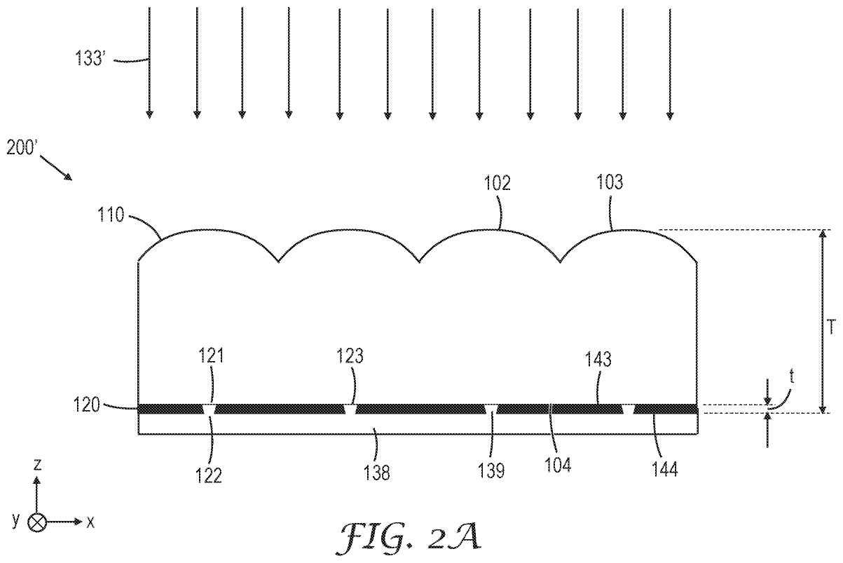

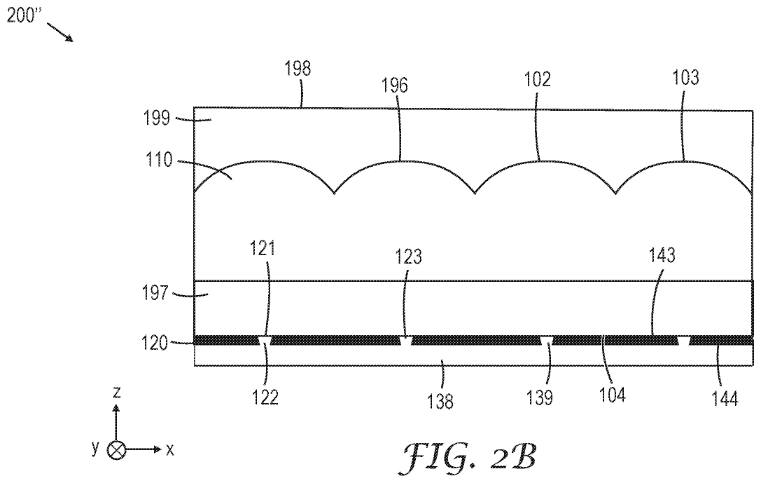

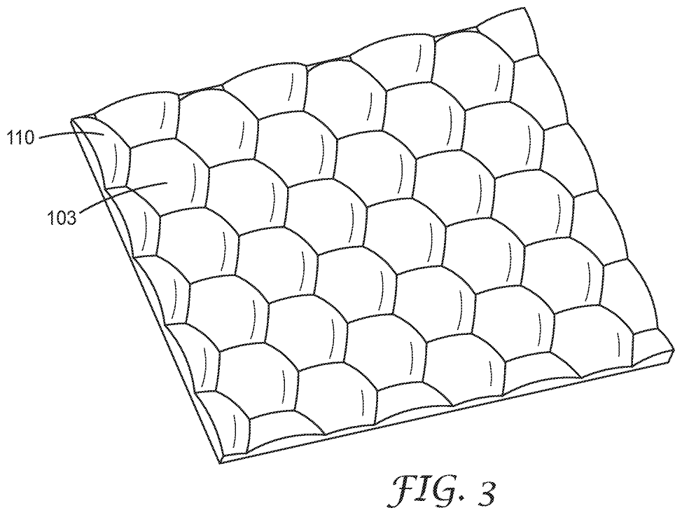

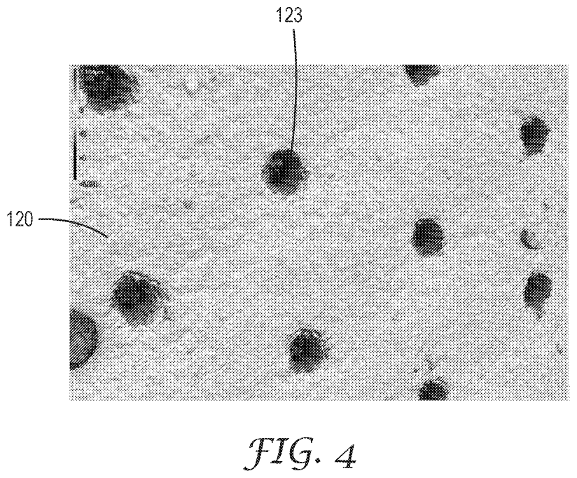

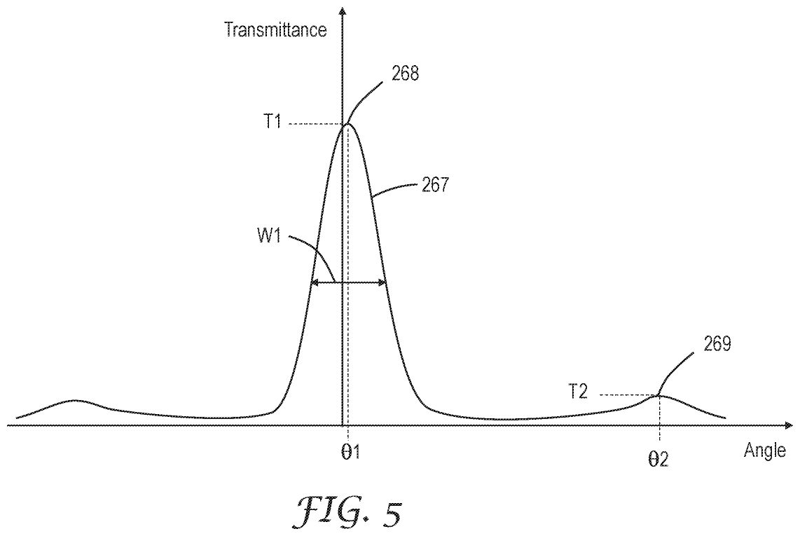

FIG. 1 is a schematic cross-sectional view of an optical construction 200 including a lens film 110 and a mask layer 120, according to some embodiments. FIGS. 2A-2B are schematic cross-sectional views of optical constructions 200′, 200″ including a lens film 110 and a mask layer 120 and one or more optional additional layers or films, according to some embodiments. Optical construction 200′ includes optional additional layer 138 and optical construction 200″ further includes optional additional layer or film 197 and optional additional layer 199. The lens film 110 has an outermost major surface 102 including a plurality of microlenses 103. The microlenses can be arranged in any suitable pattern. For example, the microlenses can be arranged in a regular two-dimensional array such as a square or hexagonal array. FIG. 3 is a top perspective view of a lens film 110 including microlenses 103, according to some embodiments. The microlens film 110 can be formed by any suitable process such as casting and curing a resin between a substrate and a tool, for example. FIG. 4 is a bottom perspective view of a mask layer 120 defining through openings 123 therein, according to some embodiments. The through openings 123 can be aligned to the microlenses 103 in a one-to-one correspondence, such that the optical construction has a desired optical transmittance for light incident on the microlenses, for example. FIG. 5 is a schematic plot of an optical transmittance 267 through an optical construction 200, 200′, 200″ as a function of a transmitted angle, according to some embodiments. The optical construction may be adapted to primarily transmit light along an incident direction (e.g., direction 134 in FIG. 1 or the minus z-direction in FIG. 2).

In some embodiments, an optical construction 200, 200′, 200″ includes a lens film 110 including an outermost structured first major surface 102 and an opposing outermost substantially planar (e.g., planar or nominally planar or planar up to variations of curvature small compared to that of the structured first major surface) second major surface 104. The structured first major surface 102 includes a plurality of microlenses 103 arranged along orthogonal first and second directions (x- and y-directions referring to the illustrated x-y-z coordinate system). The optical construction 200, 200′ includes a radiation cured optically opaque mask layer 120 disposed on the second major surface 104 of the lens film 110. The mask layer 120 has an average thickness t of less than about 10 microns and defines a plurality of laser-ablated through openings 123 therein arranged along the first and second directions. The mask layer 120 has opposing third and fourth major surfaces 143 and 144, where the third major surface 143 faces the lens film 110. The average thickness t may alternatively be described as the average separation between the third and fourth major surfaces 143 and 144. The average refers to the unweighted mean unless indicated differently. The average thickness t can be less than about 8 microns, or less than about 7 microns, or less than about 6 microns, or less than about 5 microns, or less than about 4 microns, for example. The average thickness t can be greater than about 1 micron, or greater than about 2 microns, or greater than about 2.5 microns, for example. The average thickness t can be in a range of about 2 microns to about 7 microns or about 2.5 microns to about 6 microns, for example. In some embodiments, a total thickness T of the lens film 110 and the mask layer 120 is no greater than about 100 microns (e.g., in a range of about 30 microns to about 100 microns). The lens film 110 can include a lens layer cast and cured on a substrate layer, for example, so that the thickness of the lens film is the thickness of the lens layer and the substrate layer.

A microlens is generally a lens with at least two orthogonal dimensions (e.g., a height and a diameter, or a diameter along two axes) less than about 1 mm and greater than about 100 nm. The microlenses can have an average diameter in a range of about 0.5 microns to about 500 microns, or about 5 microns to about 100 microns, for example. The microlenses can have an average radius of curvature in a range of 5 microns to 50 microns, for example. The microlenses can have any suitable shape. The microlenses can be spherical or aspherical microlenses, for example. In some embodiments, the microlenses are pillow lenses which can allow for a higher fraction of the area covered by the lenses to be optically active, for example. A pillow lens may be substantially symmetric under reflection about two orthogonal planes (e.g., planes passing through a center of the lens and parallel to the x-z plane and the y-z plane, respectively), or about three planes parallel to the thickness direction of the lens film where each plane makes an angle of about 60 degrees with each other plane, without being rotationally symmetric about any axis. The optical construction 200, 200′, 200″ can have a total thickness in a range of about 10 microns to about 200 microns or about 30 microns to about 100 microns, for example.

A mask layer can be described as optically opaque when the transmittance of unpolarized visible light (e.g., wavelengths from about 400 nm to about 700 nm) normally incident on the layer in a region between openings is less than 20%, or less than 15%, or less than 10%, or less than 5%, or less than 3%, or less than 2%, or less than 1%. The mask layer can alternatively be characterized by its optical density (minus base 10 logarithm of [transmittance/100%], where the transmittance is for unpolarized normally incident visible light unless indicated differently). In some embodiments, between adjacent through openings, the mask layer has an optical density of greater than about 1.5, or greater than about 1.6, or greater than about 1.7. The mask layer can be optically absorptive so that most light incident on the mask layer between adjacent through openings is absorbed rather than reflected.

The through openings 123 are aligned to the microlenses 103 in a one-to-one correspondence, such that for a substantially collimated light 133, 133′ incident on the structured first major surface side of the optical construction 200, 200′, 200″ along an incident direction (e.g., direction 134 in FIG. 1 or minus z-direction in FIG. 2A) forming an incident angle (e.g., j in FIG. 1 or about zero degrees in FIG. 2A) with the second major surface 104 (incident angle is the angle relative to the surface normal), an optical transmittance 267 of the optical construction 200, 200′, 200″ as a function of a transmitted angle q includes a first transmitted peak 268 having a first peak transmittance T1 and a corresponding full width at half maximum W1. The substantially collimated light 133, 133′ can be collimated or nominally collimated or can have a divergence angle or convergence angle less than about 20 degrees, or less than about 10 degrees, or less than about 5 degrees, for example. The substantially collimated light 133, 133′ can fill or substantially fill at least one microlens or can fill or substantially fill a plurality of the microlenses. The incident direction can be substantially orthogonal to the first and second directions. For example, the angle j can be less than about 20 degrees, or less than about 10 degrees, or less than about 5 degrees. In some embodiments, the first transmitted peak 268 is within about 10 degrees of the incident angle (e.g., the first transmitted peak 268 can be at a first transmitted angle q1 which can be within 10 degrees of the angle j). In some such embodiments or in other embodiments, T1≤40% or T1≥50%. In some such embodiments or in other embodiments, T1/W1≥2%/degree, or T1/W1≥40%/degree, or T1/W1≥6%/degree, or T1/W1 8%/degree. For example, in some embodiments, T1≥50% and T1/W1≥4%/degree. Typically, a sharp peak (e.g., T1/W1 of 4%/degree or higher) is preferred. In some embodiments, W1 is less than about 20, or 15, or 12, or 10 degrees. In some embodiments, T1 is greater than about 50% or greater than about 55%. In some embodiments, 70%≥T1≥50%. For example, optical constructions with 70%≥T1 may be preferred in some cases since the cross-talk is typically smaller for such optical constructions than for optical constructions having a higher T1, while optical constructions with T1≥50% may be preferred in some cases to provide a desired throughput of incident light.

The substantially collimated light 133, 133′ can be visible light (e.g., wavelengths from about 400 nm to about 700 nm) or can have at least one wavelength in a visible wavelength range. In some embodiments, the optical transmittance 267 is an average optical transmittance over a wavelength range extending from at least about 450 nm to about 650 nm. In some embodiments, the optical transmittance 267 is an optical transmittance for at least one wavelength in a wavelength range extending from about 450 nm to about 650 nm (e.g., the optical transmittance can be for a wavelength of about 530 nm).

In some embodiments, the optical construction is adapted to transmit light incident along the incident direction and to substantially not transmit light incident along a direction making an angle greater than about 15 degrees with the incident direction. The incident angle j can be about zero degrees or can be greater than zero degrees depending on the incident angles which are desired to be transmitted.

In some embodiments, the optical transmittance 267 of the optical construction 200, 200′, 200″ further includes a second transmitted peak 269 having a second peak transmittance T2 at a transmitted angle q2 greater than the incident angle (e.g., j) by at least about 30 degrees. In some embodiments, T2≤4%, or T2≤3.5%, or T2≤3%, or T2≤2.5%, or T2≤2%, or T2≤1.5%, or T2≤1%, or T2≤0.5%, or T2≤0.3%. In some embodiments, T2/T1 is less than about 0.07, or less than about 0.05. In some embodiments, 0.3%≤T2≤3% or 0.5%≤T2≤2.5%. A second peak transmittance T2 appreciably greater than 4% is typically undesired as this can result in undesired cross-talk. In some embodiments, the second peak is not present or is too small to be discerned in a plot of the optical transmittance versus transmitted angle. The second peak may be present for angles along a first direction (e.g., a down-web direction) but not along an orthogonal second direction (e.g., a cross-web direction). This may result from shape variations in the microlenses arising the process (e.g., a cast and cure process) used to form the microlens film.

In some embodiments, the mask layer 120 is formed by coating the second major surface 104 of the lens film 110 with a mixture comprising oligomer, optically absorptive material (e.g., pigment(s) and/or dye(s) that collectively absorb in visible and infrared wavelength ranges), and no more than about 25 weight percent monomer; radiation curing the coating to form an optically opaque mask layer; and then laser ablating holes through the mask layer. In some embodiments, the mask layer can be described as a polymeric layer (i.e., a layer having a continuous phase of organic polymer). For example, the mask layer can be a radiation cured polymeric optically opaque mask layer.

The mask layer 120 can comprise polyurethane. For example, in some embodiments, the mask layer 120 is preparable from a mixture comprising one more urethane acrylates. The urethane acrylates can be oligomers. An oligomer can have a number-average molecular weight (Mn) in a range of about 300 to 3000 Daltons, or about 400 to 2500 Daltons, for example. In some embodiments, the mask layer is preparable from a mixture comprising one more urethane acrylates at 50 to 90 weight percent in total. In some embodiments, the one more urethane acrylates comprises one or more urethane diacrylates. In some embodiments, the one more urethane acrylates comprises one or more aliphatic urethane acrylates. In some embodiments, the one more urethane acrylates comprises one or more aromatic urethane acrylates. Useful aliphatic urethane diacrylate oligomers include, for example, those available from Allnex USA Inc. (Alpharetta, GA) under the EBECRYL tradename and those available from IGM Resins USA Inc. (St. Charles, IL) under the PHOTOMER tradename. The number average molecular weight can be determined by gel-permeation chromatography, viscometry or colligative methods such as vapor pressure osmometry.

The mixture can include at least about 50 or at least about 60 weight percent oligomer. The oligomer can have a number-average molecular weight per linking group of at least about 100 Daltons per linking group or at least about 150 Daltons per linking group. In some embodiments, the oligomer has a number-average molecular weight per linking group in a range of about 100 to 2000 Daltons per linking group, or about 150 to 1500 Daltons per linking group, or about 200 to 1000 Daltons per linking group. In some embodiments, the mixture comprises oligomer at 50 to 90 weight percent. The oligomer can include one or more urethane acrylates as described further elsewhere herein. In some embodiments, the mask layer is preparable form a mixture comprising oligomer at 50 to 90 weight percent, where the oligomer has a number-average molecular weight per linking group in a range of about 100 to 2000 Daltons per linking group or in another range described elsewhere herein.

In some embodiments, the mixture comprises oligomer, optically absorptive material, and no more than about 25 weight percent monomer, or no more than about 20 weight percent monomer, or no more than about 15 weight percent monomer. It has been found that a low monomer content (e.g., £25, 20, or 15 weight percent) can result in good through hole shape definition but that some monomer content (e.g., ³2, 4, or 6 weight percent) may be desired for coatability. The monomer can have a molecular weight of less than about 250 Daltons or less than about 200 Daltons, for example. The monomer can be a monomer diluent. The monomer diluent can be a monofunctional acrylate, for example. The monofunctional acrylate can be or include phenoxy ethyl acrylate, for example. In some embodiments, the mixture is substantially free of monomer (e.g., no more than about 1 weight percent monomer).

It has been found that a low crosslinking density of the polymeric phase of the mask layer and/or a high molecular weight, and/or high molecular weight per linking group, of the oligomer used in forming the mask layer can result in improved shape definition of through openings formed in the mask layer compared to using radiation cured polymer systems formed from curing monomers that result in high crosslinking density. In some embodiments, a crosslinking density of a polymeric phase of the mask layer is sufficiently low so that in at least a first cross-section of the optical construction along a thickness direction of the optical construction and substantially bisecting a first opening in the plurality of through openings, the first opening has opposing first and second sidewalls, where a best linear fit to at least one of the first and second sidewalls has an r-squared value of greater than about 0.8. In some embodiments, a crosslinking density of a polymeric phase of the mask layer is sufficiently low so that each through opening has an open end at the major surface having a shape having a circularity being 4p times an area of the shape divided by a square of a perimeter of the shape, where the circularities of the shapes of the open ends of at least about 20% of the through openings are at least about 0.75 and the areas of the shapes of the open ends of the through openings have an average A and a standard deviation of less than about 12% of A. In some embodiments, a crosslinking density of a polymeric phase of the mask layer is sufficiently low so that for a substantially collimated light incident on the structured first major surface side of the optical construction along an incident direction forming an incident angle with the second major surface, an optical transmittance of the optical construction as a function of a transmitted angle has a first transmitted peak having a first peak transmittance T1 and a corresponding full width at half maximum W1, where the first transmitted peak is within about 10 degrees of the incident angle, T1≥50%, and T1/W1≥4%/degree. In some embodiments, the oligomer has a molecular weight sufficiently high that in at least a first cross-section of the optical construction along a thickness direction of the optical construction and substantially bisecting a first opening in the plurality of through openings, the first opening has opposing first and second sidewalls, where a best linear fit to at least one of the first and second sidewalls has an r-squared value of greater than about 0.8. In some embodiments, the oligomer has a molecular weight sufficiently high that each through opening has an open end at the major surface has a shape having a circularity being 4p times an area of the shape divided by a square of a perimeter of the shape, where the circularities of the shapes of the open ends of at least about 20% of the through openings being at least about 0.75 and the areas of the shapes of the open ends of the through openings have an average A and a standard deviation of less than about 12% of A. In some embodiments, the oligomer has a molecular weight sufficiently high that for a substantially collimated light incident on the structured first major surface side of the optical construction along an incident direction forming an incident angle with the second major surface, an optical transmittance of the optical construction as a function of a transmitted angle has a first transmitted peak having a first peak transmittance T1 and a corresponding full width at half maximum W1, where the first transmitted peak is within about 10 degrees of the incident angle, T1≥50%, and T1/W1≥4%/degree. Further characterizations of the shapes of the through openings are described elsewhere herein.

After the mixture is coated onto the lens film, the mixture can be cured by applying actinic radiation such as ultraviolet radiation or electron-beam radiation. The mixture can include photoinitiator as is known in the art. The photoinitiator can be included at 2 to 5 weight percent, for example. In some embodiments, the photoinitiator comprises phenylbis(2,4,6-trimethylbenzoyl)phosphineoxide. In some embodiments, the mixture further comprises dispersant at 2 to 7 weight percent. Suitable dispersants include those available from Lubrizol Corporation (Wickliffe, OH) under the tradename SOLSPERSE, for example.

In some embodiments, the mixture is substantially free of solvent (e.g., any solvent that may be included can be present in a sufficiently low amount so as to not appreciably affect the viscosity of the mixture). In other embodiments, the mixture includes solvent to lower the viscosity of the mixture to facilitate coating the lens film with the mixture. The mixture can be dried to remove the solvent after coating. It can be useful to include solvent when high molecular weight oligomers are included in the mixture. Suitable solvents include alcohols, ketones, esters, hydrocarbons, glycols, glycol ethers, and glycol esters. Some of these solvents can be high boiling and may be present in small amounts in the coating solution. High boiling hydrocarbons and petroleum naptha and aromatics can optionally also be present in small amounts. Though typically not intentionally added, small amounts of water or moisture can be present in some polar solvents. Nitriles, aminoethanols, amines can also be used as a co-solvent. The preferred solvent may be determined by oligomer choice as well as process type and conditions (e.g., temperature). Typical preferred solvents include ketones and low boiling alcohols.

The mixture can include optically absorptive material. For example, the mixture can include one or more pigments and/or dyes. In some embodiments, the optically absorptive material comprises one or more infrared absorptive materials. In some such embodiments, or in other embodiments, the optically absorptive material comprises one or more visible light absorptive materials. For example, it is typically desired that the mask layer absorb visible light so that it functions as a visible light mask and that the mask layer absorb infrared light so that an infrared laser can be used to ablate through openings in the mask layer. Carbon black, for example, can absorb in both a visible and an infrared wavelength range. In some embodiments, the mixture includes carbon black at about 5 to 30 weight percent, or about 10 to 20 weight percent, or about 12 to 18 percent, for example. The optically absorptive material can include visible dyes, infrared dyes, or a combination thereof.

The optically absorptive material can be a pigment. The pigment can be or include an organic pigment, an inorganic pigment, a metal organic pigment, or a combination thereof. The pigment, or combination of pigments, preferably absorbs both visible and infrared (IR) light (e.g., in a wavelength range from 1000 nm-1100 nm or in other near infrared ranges described elsewhere herein). The absorption strength of the pigment, or combination of pigments, may be similar or different in the visible and infrared part of the light spectrum. It is typically preferred to have a pigment, or combination of pigments, or a dye or combination of dyes or of dye(s) and pigment(s), which has stronger light absorption in the visible than in the IR to achieve sufficient visible light blocking but also have adequate absorption in the IR for laser ablation. A suitable organic pigment is carbon black, for example. Suitable inorganic pigments are metal oxides such as mixed valent iron oxide, iron-manganese or copper iron spinel oxides, for example. The pigment is preferably a broad band absorber (e.g., carbon black). For making a stable coating solution, carbon black may be generally uniformly dispersed with the aid of a dispersant. A dispersant can be a surfactant molecule in simple form or a polymer which has affinity both for the pigment particle as well as for the polymer resin and is also soluble in the solvent. In some embodiments, the average particle size of the pigment (e.g., carbon black) is less than 1 micron, or less than 500 nm, or less than 250 nm, or less than 100 nm. For example, the average particle size can be in a range of 5 nm or 10 nm or 20 nm to 250 nm. It is possible to have a distribution of pigment particles with various sizes. The average particle size can be understood to be the Dv50 value (median particle size in a volume distribution). In some embodiments, pigment is included in the mask layer at about 10 to about 35 weight percent or at about 15 to about 30 weight percent.

The optically absorptive material can include visibly transparent infrared absorbing conducting oxides in the form of nanoparticle powders and dispersions, e.g., indium tin oxide (ITO), antimony tin oxide (ATO), gallium tin oxide (GTO), antimony zinc oxide (AZO), aluminum/indium doped zinc oxide, doped tungsten oxides such as cesium tungsten oxides, and tungsten blue oxides. Exemplary nanoparticles are available from Nissan Chemical, Nagase, Sumitomo Metal and Mining, and Evonik.

The optically absorptive material can include infrared absorbers with some visible colors and transmission, e.g., cobalt aluminate spinels, cobalt chromite spinels, cobalt phosphates, other transition metal spinel oxides, copper oxides, copper phosphates, LiFePO4, and other iron phosphates and iron oxides, yttrium indium manganese oxides or yttrium indium manganese oxide, YInMn blue, and nanoparticles of these compositions. Further suitable infrared absorbers can include lanthanide glasses, lanthanide oxides, or lanthanide phosphates, where the lanthanide ion is selected from the lanthanide group in the periodic table. Suitable visibly transparent infrared absorbing materials further include metal borides such as lanthanum hexaborides and other lanthanide boride nanoparticles, metal nitrides, and metal oxynitrides. The optically absorptive material can also include visibly transparent infrared absorbing polymer nanoparticles such as conducting polymer nanoparticles such as PEDOT-PSS.

In one or more embodiments, the optically absorptive material can include non-oxide infrared absorbing nanoparticles that have some visible light transmission such as metal chalcogenides including metal sulfides, selenides such as copper sulfide and copper selenide nanoparticles, and tungsten disulfides and molybdenum disulfides.

In one or more embodiments, the optically absorbing material can include visibly transparent tunable infrared absorbers such as metallic plasmonic nanoparticles that include at least one of gold, silver, copper, etc. Some metal oxides (e.g., tungsten and molybdenum “bronze” type oxides) and metal chalcogenides (e.g., copper sulfide and selenides with high electronic conductivity) also exhibit plasmonic effects. These plasmonic nanoparticles can exhibit tunable visible and IR absorption based upon their sizes and shapes.

In one or more embodiments, the optically absorptive material can include visibly transparent near infrared absorbing dyes and pigments. These dyes can have low visible absorption but strong narrow band infrared absorption. Many of these dyes and pigments are organic/organometallic or metal organic in nature. Some major classes of these dyes and pigments include a diammonium dye, an anthraquinone dye, an aminium dye, a cyanine dye, a merocyanine dye, a croconium dye, a squarylium dye, a rylene dye, an azulenium dye, a polymethine dye, a naphthoquinone dye, a pyrylium dye, a phthalocyanine dye, a naphthalocyanine dye, a naphthlolactam dye, an azo dye, an indigo dye, a perinone dye, a terrylene dye, a dioxidine dye, a quinacridone dye, an isodorynone dye, a quinophthalone dye, a pyrrole dye, or a thioindigo dye, transitional metal dithiolene dye, quinone dye, anthraquinone dye, iminium dye, thiapyrilium dye azulenium dye, and indoaniline dye. Many of these dyes and pigments can exhibit both visible and infrared absorption as well.

Further, in one or more embodiments, the optically absorptive material can include visible dyes and colorants that exhibit infrared transparency and that fall into one or more classes such as acid dyes, azoic coloring materials and coupling components, diazo components, basic dyes that include developers such as direct dyes, disperse dyes, fluorescent brighteners, food dyes, ingrain dyes, leather dyes, mordant dyes, natural dyes and pigments, oxidation bases, pigments, reactive dyes, reducing agents, solvent dyes, sulfur dyes, condense sulfur dyes, and vat dyes. Suitable organic dyes belong to one or more monoazo, azo condensation, insoluble metal salts of acid dyes, and disazo, naphthols, arylides, diarylides, pyrazolone, acetoarylides, naphthanilides, phthalocyanines, anthraquinone, perylene, flavanthrone, triphendioxazine, metal complexes, quinacridone, and polypryrrolopyrrole dyes.

In one or more embodiments, the optically absorptive material can include metal oxide pigments such as metal chromates, molybdates, titanates, tungstates, aluminates, and ferrites. Many contain transition metals such as iron, manganese, nickel, titanium, vanadium, antimony, cobalt, lead, cadmium, chromium etc. Bismuth vanadates are non-cadmium yellows. These pigments can be milled to create nanoparticles that can be useful where transparency and low scattering is desired. These oxides may exhibit selective visible and/or infrared absorption. Further suitable metal oxide pigments include carbon black, activated charcoal, and lamp black, which exhibit both visible and IR absorption.

In some embodiments, in at least a first cross-section of the outermost structured first major surface in a direction substantially orthogonal to the first and second directions and substantially bisecting a first opening 123a in the plurality of through openings 123, the first opening 123a has a larger first width d1 on a side of the mask layer 120 facing the lens film 110 and a smaller second width d2 on a side of the mask layer 120 facing away from the lens film 110 (see, e.g., FIG. 1). In other embodiments, the first width d1 is smaller than the second width d2. In some embodiments, d1 and d2 are about equal. The relative widths of d1 and d2 may depend on material choice for the mask layer and on laser ablation processing conditions. Adjusting shapes of through holes via laser processing conditions is generally described in in U.S. Pat. No. 7,864,450 (Segawa et al.), for example. In some embodiments, a ratio (d1/d2) of the first width d1 to the second width d2 is in a range of about 1.1 to about 2.

In some embodiments, the microlenses 103 are arranged in a hexagonal pattern (see, e.g., FIG. 3). In some embodiments, the microlenses fill a large fraction (at least about 85%) of a total area of the structured first major surface 102 so that a large fraction of the total area is optically active (e.g., changes a divergence angle of incident light). In some embodiments, at least about 85%, or at least about 90%, or least about 95%, or at least about 98% of a total area of the structured first major surface 102 is optically active.

In some embodiments (see, e.g., FIGS. 2A-2B), a layer 138 is disposed on the mask layer 120 opposite the lens film 110. In some such embodiments, material 139 (e.g., polymeric material and/or a low index optical adhesive material) from the layer 138 at least partially fills some or all of the through openings 123 (e.g., the layer 138 can cover substantially the entire mask layer so that all of the through openings are at least partially filled or the layer 138 can be disposed over only a portion of the mask layer so that only some of the through openings are at least partially filled). In some embodiments, the mask layer 120 has a first refractive index (the refractive index of the material forming the mask layer) and at least some of the through openings are at least partially filled with a polymeric material 139 having a second refractive index. In some embodiments, a real part of the second refractive index is less than a real part of the first refractive index. For example, in some embodiments, the real part of the first refractive index minus the real part of the second refractive index is at least about 0.05. Refractive indices can be understood to be determined at a wavelength of 532 nm except where indicated differently.

In some embodiments (see, e.g., FIG. 2B), a layer or film 197 is disposed between the lens film 110 and the mask layer 120. The layer or film 197 can be a wavelength selective layer or film. For example, the layer or film 197 can include dye(s) and/or pigment(s) that absorb in some wavelength range(s) and not others. As another example, the layer or film 197 can be a multilayer optical film reflecting in some wavelength range(s) and not others. As is known in the art, multilayer optical films including alternating polymeric layers can be used to provide desired reflection and transmission in desired wavelength ranges by suitable selection of layer thicknesses. Multilayer optical films and methods of making multilayer optical films are described in U.S. Pat. No. 5,882,774 (Jonza et al.); 6,783,349 (Neavin et al.); 6,949,212 (Merrill et al.); 6,967,778 (Wheatley et al.); and 9,162,406 (Neavin et al.), for example. Preferably, the layer or film 197 is substantially transmissive for a visible wavelength range (e.g., about 450 to about 650 nm) and a near infrared wavelength range (e.g., 900 to 1000 nm). In some embodiments, the layer or film 197 absorbs or reflects in at least a portion of a wavelength range from about 650 nm to about 900 nm, for example.

In some embodiments (see, e.g., FIG. 2B), a layer 199 is disposed on the structured first major surface 102 of the lens film 110. The layer 199 can have a major surface 196 substantially conforming to the structured major surface 102 and an opposite substantially planar major surface 198. In other words, the layer 199 can substantially planarize the structured first major surface 102. The layer 199 can be a low index layer. In some embodiments, the layer 199 has a refractive index less than about 1.4, or less than about 1.35, or less than about 1.3, or in a range of about 1.1 to about 1.35 or to about 1.3, for example. In some embodiments, the layer 199 can have a refractive index at least 0.1, or at least 0.2, or at least 0.3 lower than that of the lens layer 110. The low index layer may be a nanovoided layer as described in U.S. Pat. Appl. Publ. Nos. 2013/0011608 (Wolk et al.) and 2013/0235614 (Wolk et al.), for example.

In some embodiments, any one, two or all three of elements 138, 197 and 199 can be omitted. In some embodiments, layer or film 197 is omitted and layer 138 includes dye(s) and/or pigment(s) that absorb in some wavelength range(s) and not others.

In some embodiments, the material in the through openings 123 is air or an optically transparent material. In some embodiments, each through opening in at least a majority of the through openings has an optical density less than about 0.3, or less than about 0.2, or less than about 0.15, or less than about 0.1. In some such embodiments, or in other embodiments, between adjacent through openings, the mask layer 120 has a substantially uniform optical density of greater than about 1.5. Substantially uniform optical density refers to optical density that is uniform to a good approximation on a length scale of about 1 micron. For example, each cylindrical region through the mask layer 120 between through openings having a diameter of about 1 micron can have an optical density within about 15% or within about 10% or within about 5% of an average optical density of such regions. In some embodiments, a mask layer having a substantially uniform optical density is obtained by using optically absorptive particles (e.g., carbon black particles) having an average diameter substantially smaller than 1 micron (e.g., less than about 250 nm) and substantially uniformly dispersed in the layer at a loading sufficiently high that an average center to center spacing between the particles is less than about 1 micron. In some embodiments, the through openings 123 have an average diameter in a range of about 1 micron to about 10 microns, or about 2 microns to about 8 microns. The diameter d0 of a through opening can be understood to be the diameter of a cylinder having a length equal to the thickness t and having a volume equal to the volume of the through opening (e.g., the diameter d0 may be about equal to (d1+d2)/2 in FIG. 1). The average diameter is the diameter d0 averaged (unweighted mean) over the through openings. The average of d1 or the average of d2 may also or alternatively be specified. In some embodiments, for at least one of the third and fourth major surfaces 143 and 144, the open ends at the major surface (e.g., open ends 121 at major surface 143 or open ends 122 at major surface 144) have an average diameter in a range of about 1 micron to about 10 microns, or about 2 microns to about 8 microns. The diameter of an open end can be understood to be the diameter of a circle having a same area as the open end. The average diameter of the open ends is diameter averaged (unweighted mean) over the open ends. In some embodiments, 0.5 £d/t £2, where d is the average d0, d1, or d2 and t is the average thickness of the mask layer.

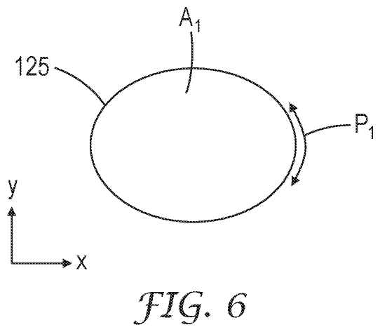

In some embodiments, each opening in at least a substantial fraction (e.g., at least about 20%) of the through openings has at least one open end having a high circularity (e.g., at least about 0.7, or at least about 0.75, or at least about 0.78, or at least about 0.8). The circularity (C) of a shape is 4p times an area A₁ of the shape divided by a square of a perimeter P₁ of the shape (i.e., C=4 pA₁/P₁²). The circularity, which is also referred to as the isoperimetric ratio, is 1 for a circle and less than 1 for any other shape (by a mathematical result known as the isoperimetric inequality). Circularity is a commonly used parameter to describe how close to a circle an object is and is often determined automatically by software in a digital camera, for example. FIG. 6 is a schematic view of a shape 125 of an open end (e.g., open end 121 at major surface 143 or open end 122 at major surface 144) of a through opening. The shape 125 has an area A₁ and a perimeter P₁ (length around the area A₁). The geometry of the open ends at the major surface 144 can be determined from a microscope image of the major surface 144. The geometry of the open ends at the major surface 143 can be determined by first coating the microlenses 103 with an index matching coating to substantially planarize the major surface 102. The open ends at the major surface 143 can then be determined from a microscope image of the major surface 143 viewed through the planarizing layer and the lens film 110.

In some embodiments, for at least one major surface of the mask layer 120 (e.g., for at least one of the third and fourth major surfaces 143 and 144), each through opening 123 has an open end at the major surface (open end 121 at major surface 143 and/or open end 122 at major surface 144). In some embodiments, the circularities of the shapes 125 of the open ends of at least about 20% of the through openings 123 is at least about 0.75. In some such embodiments or in other embodiments, the areas of the shapes 125 of the open ends of the through openings 123 having an average A (e.g., the unweighted mean of the areas A₁ can be A) and a standard deviation (e.g., standard deviation of the areas A₁) of less than about 15% of A. In some embodiments, the standard deviation is less than about 12% of A, or less than about 10% of A, or less than about 8% of A.

In some embodiments, the at least about 20% of the through openings include at least about 50%, or at least about 60%, or at least about 70%, or at least about 80%, or at least about 90% of the through openings. In some embodiments, the circularities of the shapes of the open ends of the at least about 20% of the through openings is at least about 0.7, or at least about 0.75, or at least about 0.78, or at least about 0.8. In some embodiments, the circularities of the shapes of the open ends of at least about 50% of the through openings is at least about 0.7, or at least about 0.75, or at least about 0.78, or at least about 0.8. In some embodiments, the circularities of the shapes of the open ends of at least about 70% of the through openings is at least about 0.7, or at least about 0.75, or at least about 0.78, or at least about 0.8. In some embodiments, the circularities of the shapes 125 of the open ends of the through openings 123 have an average of at least about 0.7, or at least about 0.75, or at least about 0.78, or at least about 0.8. In some embodiments, the circularities of the shapes 125 of the open ends of the through openings 123 have an average of at least about 0.7, or at least about 0.75, or at least about 0.78, or at least about 0.8 and a standard deviation of less than about 0.2. In some embodiments, the standard deviation is less than about 0.18 or less than about 0.16 or less than about 0.14.

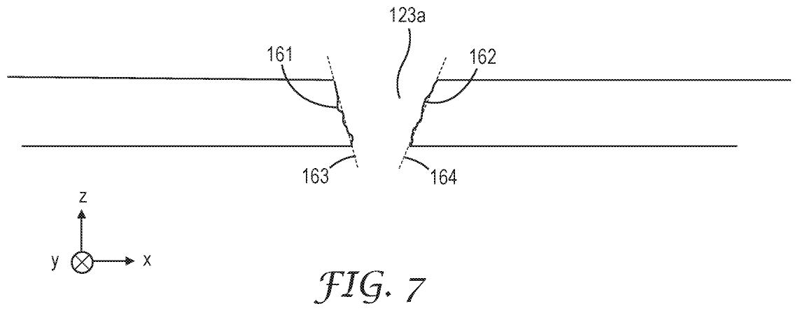

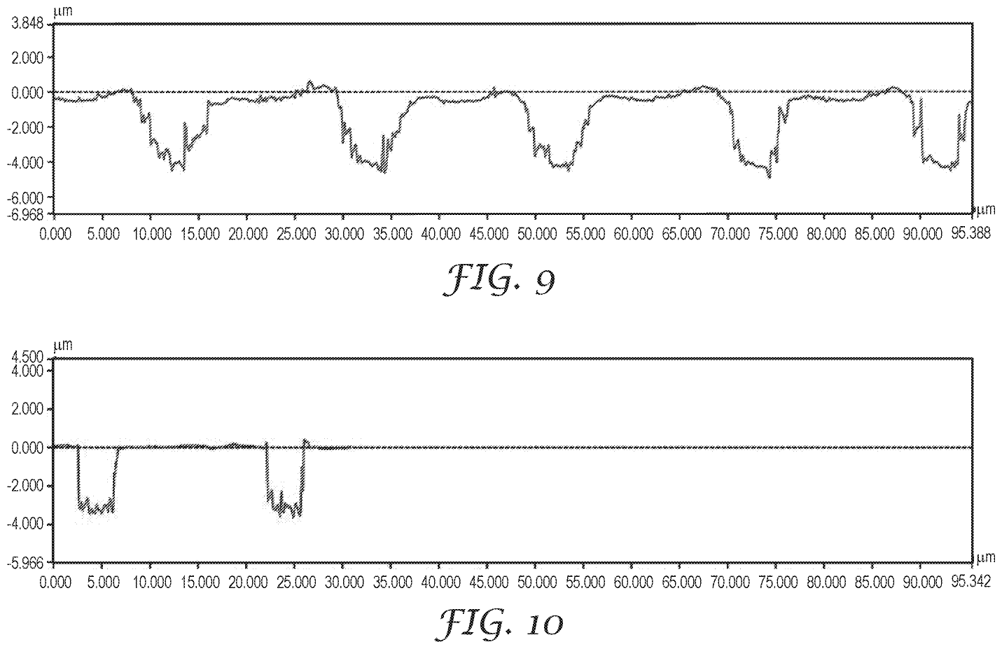

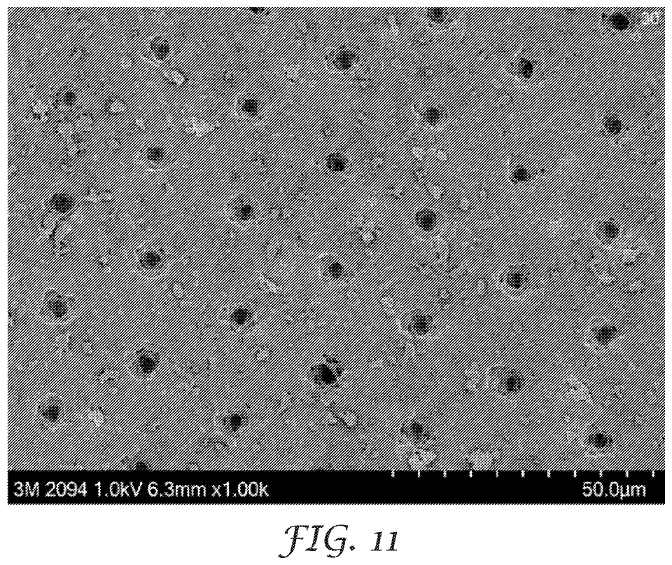

FIG. 7 is a schematic view of a cross-section of a portion of an optical construction. In some embodiments, in at least a first cross-section of the optical construction in a direction (e.g., a thickness direction of the optical construction) substantially orthogonal to the first and second directions (i.e., the first cross-section contains the direction substantially orthogonal to the first and second direction) and substantially bisecting (e.g., bisecting into two substantially equal parts having volumes within about 20% or within about 10% or within about 5% of one another) a first opening 123a in the plurality of through openings 123, the first opening 123a includes opposing first and second sidewalls 161 and 162, where a best linear fit to at least one of the first and second sidewalls (e.g., linear fit 163 to first sidewall 161 and/or linear fit 164 to second sidewall 162) has an r-squared value of greater than about 0.7, or greater than about 0.8, or greater than about 0.85, or greater than about 0.9, or greater than about 0.95. In some such embodiments or in other embodiments, in the first cross-section, the first opening has a larger width d1 on a side of the mask layer 120 facing the lens film 110 and a smaller width d2 on a side of the mask layer 120 facing away from the lens film 110 (see, e.g., FIG. 1). In some embodiments, the best linear fit to each of the first and second sidewalls has an r-squared value of greater than about 0.7, or greater than about 0.8, or greater than about 0.85, or greater than about 0.9, or greater than about 0.95. The r-squared value, which is sometimes referred to as the coefficient of determination, can be determined from a linear least squares fit, as is known in the art. The best linear fit to a sidewall is determined for the position of the sidewall along the direction (e.g., z-direction) substantially orthogonal to the first and second directions of the optical construction as a function of distance along an orthogonal direction (e.g., x-direction) in the first cross-section, unless indicated differently. For example, a sidewall may be described in terms of the z-coordinate of the sidewall as a function of x-coordinate and the best linear fit may be expressed as z=a x+b for constants a and b. In some embodiments, the slope a is greater than about 1, 2, 3, 4, or 5 (microns per micron), for example. The slope a can be up to about 200, 100, or 50, for example. FIGS. 9-10 shows measured profiles through cross-sections of through holes in a conventional UV cured mask layer (FIG. 9) and a mask layer of the present description (FIG. 10).

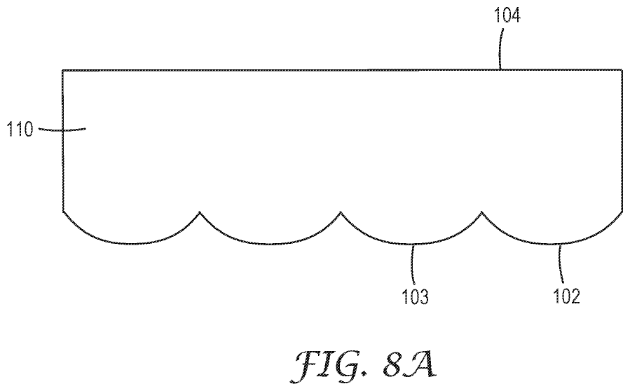

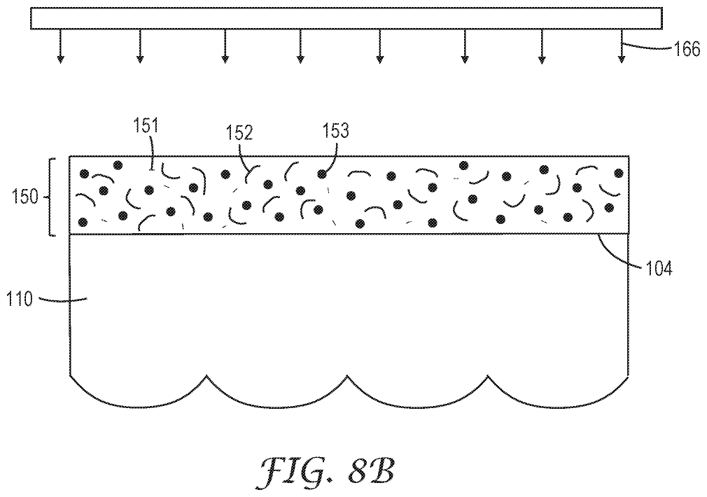

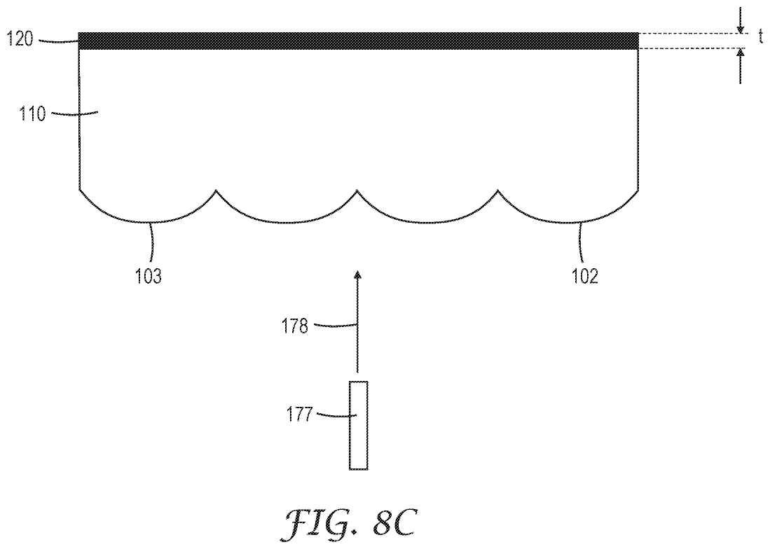

FIGS. 8A-8C are schematic illustrations of steps in a method of making an optical construction (e.g., 200 or 200′ or 200″). The method includes providing a lens film 110 (see, e.g., FIG. 8A) including an outermost structured first major surface 102 and an opposing outermost substantially planar second major surface 104, where the structured first major surface 102 includes a plurality of microlenses 103 arranged along orthogonal first and second directions; coating (see, e.g., FIG. 8B) the second major surface of the lens film with a mixture 150 comprising oligomer 152, optically absorptive material 153, and no more than about 25 weight percent monomer 151; radiation curing (see, e.g., radiation 166 schematically illustrated in FIG. 8B) the coated mixture to form a mask layer 120 having an average thickness t of less than about 10 microns and a substantially uniform optical density of greater than about 1.5; and ablating (see, e.g., FIGS. 8C, 1, and 2A-2B) a plurality of through openings 123 in the mask layer 120 using a laser 177 emitting infrared light 178 incident on the structured first major surface 102 of the lens film 110 such that the through openings 123 are arranged along the first and second directions and are aligned to the microlenses 103 in a one-to-one correspondence. The infrared light 178 can have wavelengths in a range described elsewhere herein (e.g., 1020 nm to 1100 nm). The infrared light 178 can have a wavelength at a peak intensity of about 1064 nm, for example. The infrared light 178 can have a beam diameter that fills or substantially fills at least one microlens. The optically absorptive material 153 is preferably optically absorptive for the wavelength range of the infrared light 178 as well as for a visible wavelength range (e.g., at least from about 450 nm to about 650 nm). The optically absorptive material 153 can be optically absorptive for visible wavelengths and for the infrared light 178 so that the optically absorptive material 153 absorbs the infrared light 178 for ablation to occur and provides the desired optical density for the resulting mask layer 120. Suitable optically absorptive material 153 includes carbon black, for example. In some embodiments, each through opening 123 in at least a majority of the through openings has an optical density less than about 0.3 or an optical density in any of the ranges described elsewhere herein for a through opening. The resulting optical construction can have an optical transmittance as described elsewhere and/or can have through openings having open ends having a circularity and/or area distribution (e.g., average area and standard deviation of the area) as described further elsewhere.

The through holes can be created using a coherent, pulsed light source (e.g., laser) with wavelengths from 400 nm-1200 nm, or from 500 nm-1100 nm, or from 1000 nm-1100 nm, or from 1020 nm to 1100 nm. For example, the light source can be a doped fiber laser that produces a near infrared (NIR) band having wavelengths from about 1020 nm to about 1100 nm. A wide range of lasers can be used for the light source. Suitable lasers include Nd:YAG lasers, fiber lasers, and diode lasers, for example. 1^{st}, 2^{nd} or 3^{rd} harmonics may be used, for example. The desired wavelength range of the laser may depend on the polymer and optically absorptive material used in the mask layer.

### EXAMPLES

All parts and percentages in the Examples are by weight unless indicated otherwise. Reagents and solvents are available from MILLIPORE-SIGMA (Burlington, MA), except wherein indicated otherwise.

| Material | Description | Available from: |
|---|---|---|
| EBECRYL | Aliphatic urethane diacrylate | Allnex USA Inc. |
| 4858 | oligomer having a molecular | (Alpharetta, GA) |
| | weight (Mn) of 442 Daltons | |
| EBECRYL | Isocyanate aliphatic functional | Allnex USA Inc. |
| 4396 | urethane acrylate having a | (Alpharetta, GA) |
| | molecular weight (Mn) of 1200 | |
| | Daltons | |
| PHOTOMER | Aliphatic urethane diacrylate | IGM Resins USA |
| 6210 | oligomer having a molecular | Inc. (St. Charles, |
| | weight (Mn) of 1400 Daltons | IL) |
| PHOTOMER | Aliphatic urethane diacrylate | IGM Resins USA |
| 6891 | oligomer having a molecular | Inc. (St. Charles, |
| | weight (Mn) of 1500 Daltons | IL) |
| Raven | Carbon black pigment | Birla Carbon USA |
| 1255 | | (Marietta, GA) |
| SOLSPERSE | Polymeric dispersant | Lubrizol |
| 39000 | | Corporation |
| | | (Wickliffe, OH) |
| IRGACURE | Phenylbis(2,4,6- | BASF (Florham |
| 819 | trimethylbenzoyl)phosphineoxide | Park, NJ) |
| | photoinitiator | |
| PEA | Phenoxy ethyl acrylate | Sartomer, Exton, |
| | | PA |
| TEMPO | (2,2,6,6-tetramethylpiperidin-1- | MILLIPORE- |
| | yl)oxyl or (2,2,6,6- | SIGMA |
| | tetramethylpiperidin-1-yl)oxidanyl | (Burlington, MA) |
| MEHQ | 4-methoxyphenol | MILLIPORE- |
| | | SIGMA |
| | | (Burlington, MA) |

### Examples 1-5

Ultraviolet (UV) curable mixtures were prepared with the parts by weight indicated in the following table. Since the polyurethane oligomers used in the UV formulation had 5000-10,000 cP viscosity, the milling of carbon black was conducted in methyl ethyl ketone (MEK) solvent.

The carbon black—MEK slurry was made through media milling process. The dispersants and solvent were first mixed using DISPERMAT CN-10 laboratory high-shear disperser (BYK-Gardner USA, Columbia MD) until fully dissolved, and then black powder was slowly added in under mixing. The slurry was composed of 18% wt black, 75.7% MEK, and 6.3% dispersant. The fully mixed slurry was milled using a LabStar laboratory media mill (Netzsch, Exton PA) with 0.2 mm yttria stabilized zirconia milling media. Small amounts of samples were taken out periodically to monitor the milling progress until reaching the desired particle size (<200 nanometers).

The particle size distributions were measured using Zetasizer Nano ZS (Malvern Instruments Inc, Westborough, MA). The samples were first diluted with the same solvent used in milling to 1:100 to 1:10000 by volume. The Z-Average particle size data were reported based on dynamic light scattering theory. The Z-Average size is the harmonic intensity averaged hydrodynamic particle diameter in the cumulants analysis as defined in ISO 13321 and ISO 22412. The size distribution was calculated from a 2-parameter fit to the correlation data as defined in the ISO standard document 13321:1996 E or ISO 22412:2008.

To this was added the oligomers and monomers. Inhibitors were added (100 ppm of TEMPO and MEHQ each) to prevent gelling during solvent elimination using a rotary evaporator. Once the MEK was removed, the photoinitiator was added to make the final composition. The mixtures were delivered through a Zenith BPB pump with a pump rate of 1.168 cc/rev to a slot coating die for 6″ wide coating on the backside of a 9″ wide 0.92 mil thick clear polyethylene terephthalate (PET) film with 20 micron microlens features. The coated mixtures were then UV cured. In some Examples, monomer diluent (PEA) was included primarily to reduce viscosity for improved pumping ability during the coating process. The monomer diluent was found to be detrimental to the laser processability when too much was included and is therefore preferably limited to no more than about 25 weight percent. The viscosities of the mixtures of Examples 1 and 5 was about 4500 cP at 25° C. The viscosities of the mixtures of Examples 2 and 3 was about 4400 cP at 25° C. The viscosity of the mixture of Example 4 was about 3700 cP at 25° C.

| | SOLSPERSE | Carbon | Oligomer | | | IRGACURE |
|---|---|---|---|---|---|---|
| Example | 39000 | Black | wt. | Oligomer | PEA | 819 |
| 1 | 4.2 | 14.0 | 78.9 | EBECRYL | 0.0 | 3.0 |
| | | | | 4858 | | |
| 2 | 4.2 | 14.0 | 62.8 | PHOTOMER | 15.7 | 3.3 |
| | | | | 6891 | | |
| 3 | 5.1 | 17.0 | 60.0 | PHOTOMER | 15.0 | 3.0 |
| | | | | 6891 | | |
| 4 | 5.1 | 17.1 | 52.4 | PHOTOMER | 22.5 | 3.0 |
| | | | | 6210 | | |
| 5 | 5.1 | 17.0 | 67.4 | EBECRYL | 7.5 | 3.0 |
| | | | | 4858 | | |

The thicknesses and optical densities (OD) of the resulting mask layers are given in the following table.

| | Thickness | |
|---|---|---|
| Example | (μm) | OD |
| 1 | 3.77 | 3.36 |
| 2 | 3.08 | 3.14 |
| 3 | 3.93 | 3.18 |
| 4 | 3.46 | 3.38 |
| 5 | 3.32 | 3.38 |

An array of through openings (pinholes) was created in the resulting mask layer by laser ablation though the microlens array. The process used a doped fiber that produced a near infrared (NIR) band from 900 nm-1100 nm wavelength. A range of average laser power from 20 watts-100 watts and laser pulse energy density from 1 mJ-200 mJ was explored. The laser energy and laser pulse energy density were adjusted to provide through holes with average diameter from about 1 to about 6 microns, while providing a desired shape and quality without causing thermal surface damage. The beam was rastered across the sample while maintaining a center to center pulse separation of about 50 microns to 100 microns.

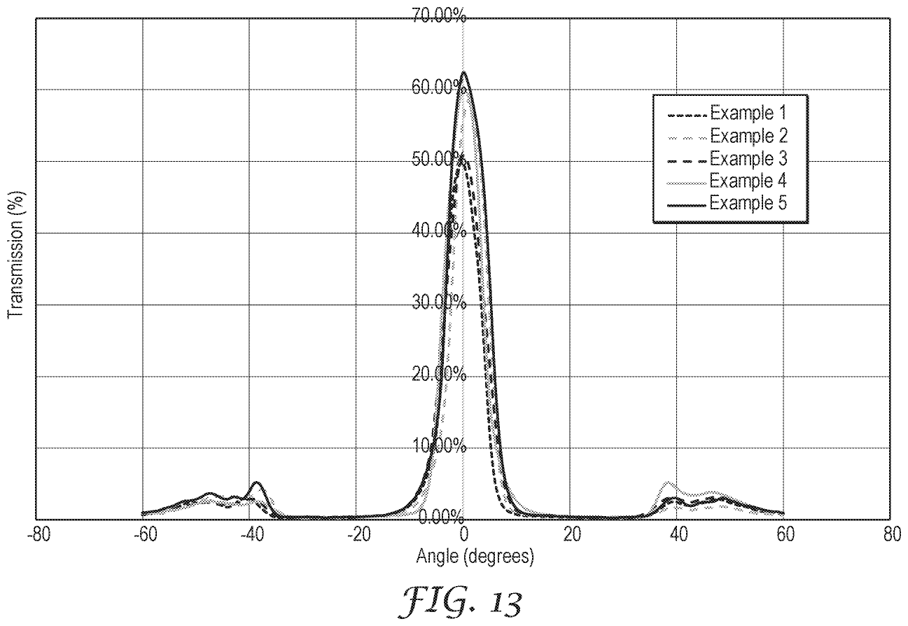

The samples were measured on a customized goniometer system that included a collimated light source and a silicon detector. The light source was a green LED with 530 nm emission wavelength attached to a collimation lens, both from Thorlabs. The light source was stationary and had a fixed illumination angle. The silicon detector had a light-sensitive area of 20 mm×20 mm and was also obtained from Thorlabs. After the microlens sample was clamped to the silicon detector, it rotated with the silicon detector along two orthogonal axes, and the optical transmittance of the sample was calculated based on the measured power transmission. FIG. 13 is a plot of the optical transmittance of the optical constructions of Examples 1-5 as a function of a transmitted angle along a down-web direction for a substantially collimated light substantially normally incident on the structured major surface side of the optical construction. FIG. 4 shows through holes in the mask layer of Example 1. FIG. 10 shows a profile of cross-sections of through holes of Example 1.

The area and circularity of the through holes on the side of the mask layer facing away from the microlenses were determined using a microscope. The average (mean) and standard deviation of the area and the circularity are reported in the table below.

| | Average | Average Area | Std. Dev. of |
|---|---|---|---|
| Example | Circularity | (mm²) | Area (mm²) |
| 1 | 0.8 | 14.8 | 1.3 |
| 2 | 0.8 | 12.3 | 1 |
| 3 | 0.8 | 13.4 | 1.4 |
| 4 | 0.8 | 13.3 | 1.7 |
| 5 | 0.8 | 14.7 | 1.7 |

### Comparative Example C1

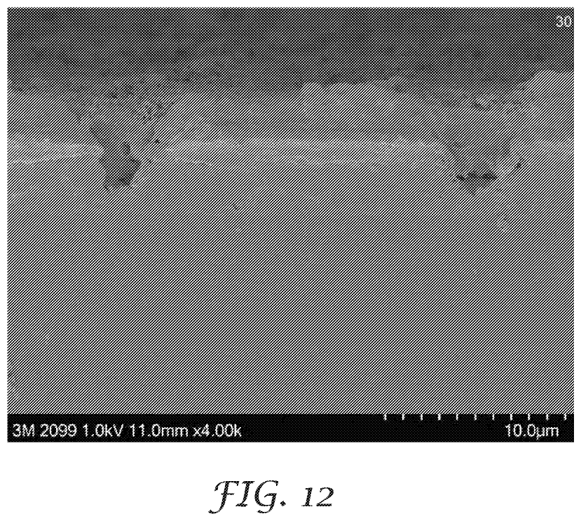

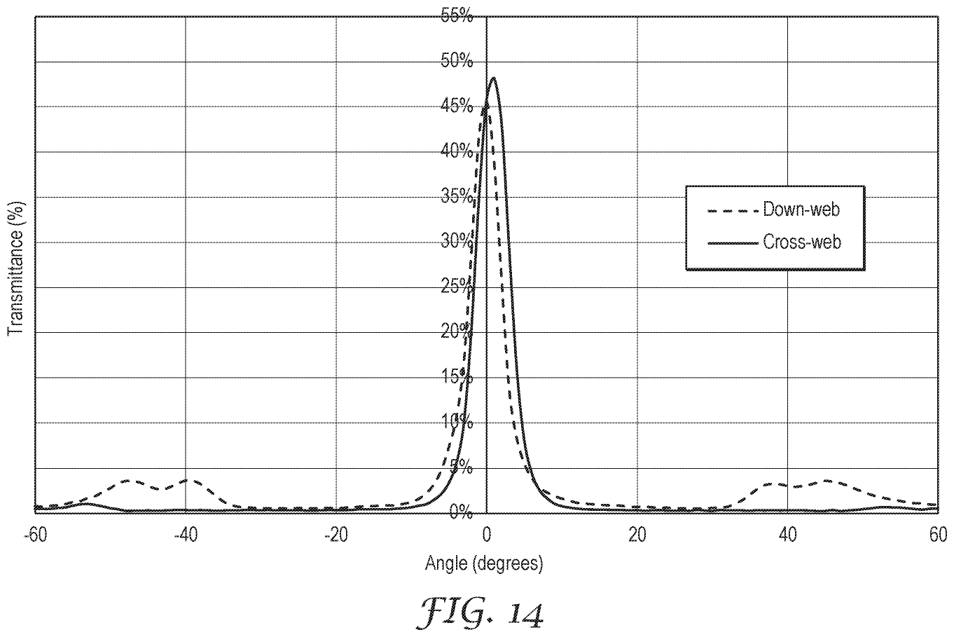

An ultraviolet (UV) curable formulation containing 11 parts carbon black, 54 parts isobornyl acrylate, 35 parts EBECRYL 4396 and 3 parts IRGACURE 819 was used. This UV curable 100% solids formulation was coated on the planar side of 9″ wide 0.92 mil thick clear PET film with 20 micron microlens features on one side. The conditions were designed so that the thickness of the coating was around 5 microns. The coating was cured using medium pressure mercury UV “D type” light source. Through holes were laser ablated through the resulting mask layer as described for Examples 1-4 and transmission through the sample was measured as described for Examples 1-4. FIG. 14 is a plot of the optical transmittance of the optical construction of Comparative Example C1 as a function of a transmitted angle along cross-web and down-web directions for a substantially collimated light substantially normally incident on the structured major surface side of the optical construction. The transmittance had peaks at greater than about 30 degrees with peak intensities greater than 3.2%. FIG. 11 is an image of through holes in the mask layer of Comparative Example C1. FIG. 12 is an image of a cross-section through two through holes in the mask layer of Comparative Example C1. The through holes exhibited poor shape definition as shown in FIGS. 11-12.

### Comparative Example C2

Comparative Example C2 was prepared as described for Comparative Example C1 except that the UV curable formulation contained 13 parts carbon black, 52 parts isobornyl acrylate, 35 parts EBECRYL 4396 and 3 parts IRGACURE 819.

### Comparative Example C3

Comparative Example C3 was prepared as described for Comparative Example C1 except that the UV curable formulation contained 15 parts carbon black, 60 parts isobornyl acrylate, 25 parts EBECRYL 4396 and 3 parts IRGACURE 819 (photoinitiator available from BASF, Florham Park, NJ) was used.

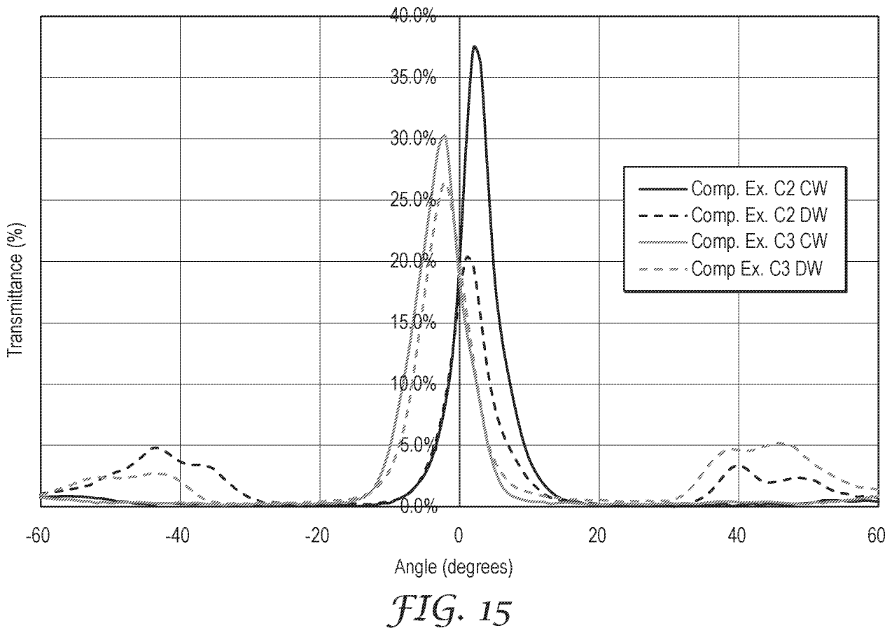

FIG. 15 is a plot of the optical transmittance of the optical constructions of Comparative Examples C2-C3 as a function of a transmitted angle along cross-web (CW) and down-web (DW) directions for a substantially collimated light substantially normally incident on the structured major surface side of the optical construction.

The ratio of the standard deviation of the areas of the through openings visible in a microscope image of the mask layer to the mean area of the through openings were determined from analysis of microscope images of Comparative Examples C1 to C3 to be 0.13, 0.18, and 0.17, respectively.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 5 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.95 and 1.05, and that the value could be 1.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. An optical construction comprising:
a lens film comprising an outermost structured first major surface and an opposing outermost substantially planar second major surface, the structured first major surface comprising a plurality of microlenses arranged along orthogonal first and second directions; and
a radiation cured optically opaque mask layer disposed on the second major surface of the lens film, the mask layer having a third major surface facing the lens film and an opposing fourth major surface, an average separation between the third and fourth major surfaces being less than about 10 microns, the mask layer defining a plurality of laser-ablated through openings therein arranged along the first and second directions, the through openings aligned to the microlenses in a one-to-one correspondence, such that for a substantially collimated light incident on the structured first major surface side of the optical construction along an incident direction forming an incident angle with the second major surface, an optical transmittance of the optical construction as a function of a transmitted angle comprises a first transmitted peak having a first peak transmittance T1≥40%, wherein the mask layer comprises optically absorptive material dispersed in a crosslinked polymeric phase, the polymeric phase having a crosslinking density sufficiently low so that for at least one of the third and fourth major surfaces, each through opening has an open end at the major surface having a shape having a circularity being 47G times an area of the shape divided by a square of a perimeter of the shape, the circularities of the shapes of the open ends of at least about 20% of the through openings being at least about 0.75, the areas of the shapes of the open ends of the through openings having an average A and a standard deviation of less than about 12% of A.

17. The optical construction of claim 16, wherein the circularities of the shapes of the open ends of the through openings have an average of at least about 0.75.

18. The optical construction of claim 16, wherein the at least about 20% of the through openings comprise at least about 50% of the through openings.

19. The optical construction of claim 16, wherein the mask layer comprises polyurethane.

20. The optical construction of claim 16, wherein mask layer is preparable from a mixture comprising oligomer at 50 to 90 weight percent, the oligomer having a number-average molecular weight per linking group in a range of about 100 to 2000 Daltons per linking group.

21. The optical construction of claim 16, wherein the first transmitted peak has a full width at half maximum W1, T1/W1≥4%/degree.

22. The optical construction of claim 16, wherein the optical transmittance of the optical construction further comprises a second transmitted peak having a second peak transmittance T2 at a transmitted angle greater than the incident angle by at least about 30 degrees, wherein T2≤4%.

23. The optical construction of claim 16, wherein in at least a first cross-section of the optical construction in a direction substantially orthogonal to the first and second directions and substantially bisecting a first opening in the plurality of through openings, the first opening comprises opposing first and second sidewalls, wherein a best linear fit to at least one of the first and second sidewalls has an r-squared value of greater than about 0.8.

24. The optical construction of claim 23, wherein in the first cross-section, the first opening has a larger first width on a side of the mask layer facing the lens film and a smaller second width on a side of the mask layer facing away from the lens film.

25. The optical construction of claim 16, wherein the through openings have an average diameter in a range of about 1 micron to about 10 microns.

26. An optical construction comprising:
a lens film comprising an outermost structured first major surface and an opposing outermost substantially planar second major surface, the structured first major surface comprising a plurality of microlenses arranged along orthogonal first and second directions; and
a radiation cured optically opaque mask layer disposed on the second major surface of the lens film, the mask layer having an average thickness of less than about 10 microns and defining a plurality of laser-ablated through openings therein arranged along the first and second directions, the through openings aligned to the microlenses in a one-to-one correspondence, wherein the mask layer comprises optically absorptive material dispersed in a crosslinked polymeric phase, the polymeric phase having a crosslinking density sufficiently low so that for a substantially collimated light incident on the structured first major surface side of the optical construction along an incident direction forming an incident angle with the second major surface, an optical transmittance of the optical construction as a function of a transmitted angle comprises a first transmitted peak having a first peak transmittance T1 and a corresponding full width at half maximum W1, the first transmitted peak within about 10 degrees of the incident angle, T1≥50%, and T1/W1≥4%/degree.

27. The optical construction of claim 26, wherein the mask layer comprises polyurethane.

28. The optical construction of claim 26, wherein mask layer is preparable from a mixture comprising oligomer at 50 to 90 weight percent, the oligomer having a number-average molecular weight per linking group in a range of about 100 to 2000 Daltons per linking group.

29. The optical construction of claim 26, wherein the optical transmittance of the optical construction further comprises a second transmitted peak having a second peak transmittance T2 at a transmitted angle greater than the incident angle by at least about 30 degrees, wherein T2≤4%.

30. The optical construction of claim 26, wherein in at least a first cross-section of the optical construction in a direction substantially orthogonal to the first and second directions and substantially bisecting a first opening in the plurality of through openings, the first opening comprises opposing first and second sidewalls, wherein a best linear fit to at least one of the first and second sidewalls has an r-squared value of greater than about 0.8.

31. The optical construction of claim 30, wherein in the first cross-section, the first opening has a larger first width on a side of the mask layer facing the lens film and a smaller second width on a side of the mask layer facing away from the lens film.

32. The optical construction of claim 26, wherein the through openings have an average diameter in a range of about 1 micron to about 10 microns.

33. A method of making an optical construction, the method comprising:
providing a lens film comprising an outermost structured first major surface and an opposing outermost substantially planar second major surface, the structured first major surface comprising a plurality of microlenses arranged along orthogonal first and second directions;
coating the second major surface of the lens film with a mixture comprising oligomer, optically absorptive material, and no more than about 25 weight percent monomer;
radiation curing the coated mixture to form a mask layer having a crosslinked polymeric phase, the mask layer having an average thickness of less than about 10 microns and a substantially uniform optical density of greater than about 1.5; and
ablating a plurality of through openings in the mask layer using a laser emitting infrared light incident on the structured first major surface of the lens film such that the through openings are arranged along the first and second directions and are aligned to the microlenses in a one-to-one correspondence, each through opening in at least a majority of the through openings having an optical density less than about 0.3, wherein the crosslinked polymeric phase of the mask layer has a crosslinking density sufficiently low so that for at least one major surface of the mask layer, each through opening has an open end at the major surface having a shape having a circularity being 4π times an area of the shape divided by a square of a perimeter of the shape, the circularities of the shapes of the open ends of at least 20% of the through openings being at least about 0.75, the areas of the shapes of the open ends of the through openings having an average A and a standard deviation of less than about 15% of A.

34. The method of claim 33, wherein the mixture comprises the oligomer at 50 to 90 weight percent.

35. The method of claim 33, wherein the oligomer has a number-average molecular weight per linking group of at least about 100 Daltons per linking group.
